(19) United States
(12) Patent Application Publication
(10) Pub. No.: US 2018/0320889 A1
(43) Pub. Date: Nov. 8, 2018

(54) Angled Candle

(71) Applicant: Richard Caldwell, Omaha, NE (US)

(72) Inventor: Richard Caldwell, Omaha, NE (US)

(21) Appl. No.: 15/588,652

(22) Filed: May 7, 2017

(51) Int. Cl. F21V 35/00; C11C 5/00

(52) U.S. Cl. CPC F21V 35/006; C11C 5/008

(57) ABSTRACT

Angling a candle from vertical via any means results in a much more efficient, durable, useful, and beautiful product. Adding a consumable wax lantern adds to all of these qualities.

### FIELD AND BACKGROUND

This disclosure relates to the field of candles. Traditional pillar candles have many flaws, included wasted wax at end of life, poor illumination, susceptibility to disturbance via even the lightest breeze, and difficult lighting (which can result in sooting and/or premature death). Plus, they're just plain ugly.

### SUMMARY

All of this can be corrected by angling the candle from vertical (using the wick as the measure) either via using a holder, or by shaping the candle's bottom with a plethora of flat sections in a conical pattern so the candle can be placed on any one of the sections and so orient the candle as desired. Angles from 4:3 to 7:3 (rise:run) work well, with more horizontal angles more useful for larger diameter candles and more vertical angles more useful for smaller diameter candles.

### BRIEF DESCRIPTION OF THE DRAWINGS

FIG. 1 is a view of a typical sectioned angled candle's bottom sighting up the wick.

FIG. 2 is a side cross-section of a typical angled candle in a holder.

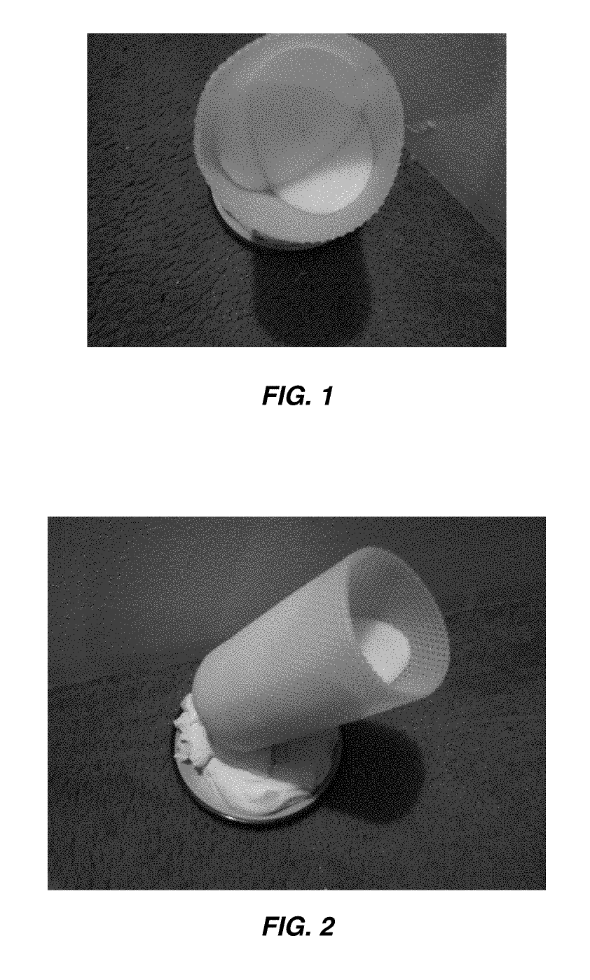

### DETAILED DESCRIPTION

The angle results in the flame etching and flaring one side of the candle's top. As the candle is burned, the user rotates the candle periodically. This exposes different sections of the candle's top/side to the flame. The user can also adjust the angle via any number of obvious ways, such as by placing the candle or holder on a wedge-shaped platform or adding adjustable legs to the holder, so as to change the intensity and location of the etching.

Rotating can be done “hot”, “warm”, or “cold”. In a hot rotation, the user grasps the candle while it is burning and moves it to the desired orientation. In warm, the user extinguishes the candle and then re-orients the candle. In cold, the user waits until the wax solidifies, then re-orients the candle.

A torch can be used after an extreme re-orientation to melt some wax above the wick and so form the new wax pool. This avoids getting soot in the wax. Another technique to avoid getting soot in the wax is raising the candle towards vertical for a short time before and/or after the rotation.

If a holder is used, the base of the candle can be the traditional flat, but it is much better to use s a pencil-point or similar style base so that the candle can be burned to a nothing. Plus, a pointed end will lock into the holder.

If the candle sits independently on a horizontal flat surface, then a pointed (conical with flat sections) base must be used, although it can be blunted. In this case, the candle stands on one of the base's flat sections (i.e., perhaps ⅛ of the base).

Cored wicks work well because they are stiffer. An inner core of beeswax or other viscous high-melting-temperature wax can aid in stiffening the wick. An outer skin of (usually bees)wax (usually sheeting), especially when colored, textured, and/or distressed with a torch, makes the candle pop, especially if the skin rises further to create a consumable lantern.

The top of the candle should have an extreme melt pool so wax doesn't pour out during the initial burn. The melt pool can become so extreme as to form a plethora of spires to hold up a consumable wax lantern.

Techniques to adjust the candle's angle are many, varied, and obvious. For example, a wedge can be placed place under the candle or holder, or the holder can have adjustable legs.

Manufacturing is via any obvious method. One technique is to pour the candle right-side-up, as opposed to the traditional upside-down, in a mold with a pointed base, be it smooth or of flat sections. using a wax with significant shrinkage, and not doing a second pour, thus forming the required deep melt pool.

Another technique is to pour the candle right-side-up, as opposed to the traditional upside-down, in a mold with a pointed base, be it smooth or of flat sections, and using the wax lantern as a dam to prevent spills.

Another technique is to pour the candle right-side-up, as opposed to the traditional upside-down, in a mold with a pointed base, be it smooth or of flat sections, and melting or otherwise removing enough wax from the top of the candle to form the required deep melt pool.

Another technique is to pour a standard upside-down mold, but with a deep melt pool and/or spires, and then, once cool enough to remove from the mold and handle, place the candle's base in a heated cone-shaped mold, where the candle will melt down to the proper cone-style-base, be it smooth or of flat sections.

Another technique is to pour a standard upside-down mold, but with a deep melt pool and/or spires, and then, once cool enough to remove from the mold and handle, carve the candle's base into the proper cone-style base, be it smooth or of flat sections.

Another technique is to form the base and top separately, with each having a hole large enough for the beeswax-sheet-wrapped-wick core to fit, and then assemble the base, top/spires, core, and skin.

Another technique is to use multiple pours, which can be done in many ways, one of which is:

I made molds for the spires by slicing thirteen-inch-long pieces of two-inch PVC pipe lengthwise, closing one end with duct tape, and raising the other end of each thirteen-inch-long half-piece of PVC pipe enough so the closed end would be full of wax when the spires were of the desired length (in this case ten inches); I rolled a warm beeswax sheet around the wick; I used a four-inch funnel for the base's mold and inserted the pre-made spires and beeswax core/wick in the base's mold prior to pouring the base; I poured the base and let it cool; I removed the candle from the base's mold; I wrapped the base in plastic wrap; I pressed the base of the candle in wet plaster at a 4.5:3 rise:run angle and let the plaster get firm; I removed the candle and plastic wrap from the holder; I wrapped a warm beeswax sheet around the spires to form the lantern; I distressed the lantern and also melded it to the base and spires with a butane torch while allowing wax drippings to decorate the plaster holder.

What is claimed is:

1. An candle comprising an angled candle portion having one of a pointed and nubbed based and a holder, the angled candle portion supported at an angle by the holder.
